(19) United States
(12) Patent Application Publication
(10) Pub. No.: US 2019/0190052 A1
(43) Pub. Date: Jun. 20, 2019

(54) FUEL CELL TUBE WITH LATERALLY SEGMENTED FUEL CELLS

(71) Applicant: LG Fuel Cell Systems, Inc., North Canton, OH (US)

(72) Inventors: Ed Daum, Minerva, OH (US); Richard Goettler, Medina, OH (US); Zhien Liu, Canal Fulton, OH (US); Charles Osborne, Akron, OH (US)

(73) Assignee: LG Fuel Cell Systems, Inc., North Canton, OH (US)

(21) Appl. No.: 15/971,876

(22) Filed: May 4, 2018

Related U.S. Application Data
(63) Continuation-in-part of application No. 15/847,456, filed on Dec. 19, 2017.

(51) Int. Cl. H01M 8/2465; H01M 8/243

(52) U.S. Cl. CPC H01M 8/2465; H01M 8/243

(57) ABSTRACT

Various embodiments of the present disclosure provide a fuel cell tube including one or more laterally segmented fuel cells each including multiple fuel cell portions that are electrically isolated from one another. When assembled into a fuel cell stack, tube interconnects electrically connect adjacent fuel cell tubes via their respective laterally segmented fuel cells. The use of laterally segmented fuel cells to effect the fuel cell tube-to-fuel cell tube electrical connection enables more accurate testing of the electrical connection between adjacent fuel cell tubes.

### RELATED APPLICATIONS

The present application is a continuation-in-part of and claims priority to U.S. patent application Ser. No. 15/847,456, filed Dec. 19, 2017, all of which is hereby incorporated by reference.

### FIELD

The present disclosure relates to fuel cell tubes. More specifically, the present disclosure relates to fuel cell tubes including one or more laterally segmented fuel cells.

### BACKGROUND

A fuel cell is an electrochemical conversion device that produces electricity by oxidizing a fuel. A fuel cell may be one of an electrochemically active fuel cell and an electrochemically inactive fuel cell (i.e. a dummy cell). An electrochemically active fuel cell typically includes an anode, a cathode, and an electrolyte between the anode and the cathode. A fuel cell tube usually includes multiple fuel cells disposed on a substrate and electrically connected to one another in series via primary interconnects. A fuel cell stack typically includes multiple fuel cell tubes electrically connected to one another in series via tube interconnects. A fuel cell system includes multiple fuel cell stacks electrically connected to one another in series and several components configured to provide the fuel to the anodes of the fuel cells and an oxidant to the cathodes of the fuel cells. The oxygen in the oxidant is reduced at the cathode into oxygen ions that diffuse through the electrolyte layers into the anodes. The fuel is oxidized at the anodes, which gives off electrons that flow through an electrical load.

### SUMMARY

Various embodiments of the present disclosure provide a fuel cell tube including one or more laterally segmented electrochemically active fuel cells or dummy cells each including lateral electrochemically active fuel cell or dummy cell portions that are electrically isolated from one another such that there is no continuous electrical path across the width of the tube. When assembled into a fuel cell stack, tube interconnects electrically connect adjacent fuel cell tubes via their respective laterally segmented fuel cells. The use of laterally segmented electrochemically active fuel cells or dummy cells to effect the fuel cell tube-to-fuel cell tube electrical connection enables more accurate testing of the electrical connection between adjacent fuel cell tubes.

In some examples, a segmented-in-series solid-oxide fuel cell system includes a first fuel cell tube, a second fuel cell tube and a first tube interconnect. The first fuel cell tube can include a substrate having a first end and an opposing second end, a first major surface extending between the first and second ends, and a second opposing major surface extending between the first and second ends. The first fuel cell tube can also include a plurality of fuel cells disposed on the first major surface, each fuel cell extending laterally across the first major surface and being positioned between the first and second ends. In some examples, a first selected one of the plurality of fuel cells on the first major surface proximate the first end is laterally segmented so that a first lateral end of the first selected fuel cell is electrically isolated from a second lateral end of the first selected fuel cell. In some examples, the fuel cell tube may comprise a “dummy” cell, i.e., a cell comprising only the cathode layer or the cathode layer with a cathode current collector layer. In some examples, an interior selected one of the plurality of fuel cells is a fuel cell adjacent the first selected fuel cell. The interior selected one of the plurality of fuel cells may be laterally segmented so that a first lateral end of the interior selected fuel cell is electrically isolated from a second lateral end of the interior selected fuel cell.

The second fuel cell tube can include a substrate having a first end and an opposing second end, a first major surface extending between the first and second ends, and a second opposing major surface extending between the first and second ends. The second fuel cell tube can also include a plurality of fuel cells disposed on the first major surface, each fuel cell extending laterally across the first major surface and being positioned between the first and second ends. In some examples, a first selected one of the plurality of fuel cells on the first major surface proximate the second end is laterally segmented so that a first lateral end of the first selected fuel cell is electrically isolated from a second lateral end of the first selected fuel cell. In some examples, the fuel cell tube may comprise a “dummy” cell, i.e., a cell comprising only the cathode layer or the cathode layer with a cathode current collector layer.

The segmented-in-series solid-oxide fuel cell system can also include a first tube interconnect electrically connecting the first lateral end of the first selected fuel cell of the first fuel cell tube to the second lateral end of the first selected fuel cell of the second fuel cell tube.

In some examples, a fuel cell tube includes a substrate defining one or more fuel conduits therethrough, the substrate having a first end and an opposing second end, a first major surface extending between the first and second ends, and a second opposing major surface extending between the first and second ends. The fuel cell tube can also include a plurality of fuel cells disposed on the first major surface, each fuel cell extending laterally across the first major surface and being positioned between the first and second ends. In some examples, a first selected one of the plurality of fuel cells on the first major surface proximate the first end is laterally segmented so that a first lateral end of the first selected fuel cell is electrically isolated from a second lateral end of the first selected fuel cell. In some examples, a first interior selected one of the plurality of fuel cells disposed on the first major surface is a fuel cell adjacent the first selected fuel cell. The first interior selected one of the plurality of fuel cells may be laterally segmented so that a first lateral end of the first interior selected fuel cell is electrically isolated from a second lateral end of the first interior selected fuel cell.

### BRIEF DESCRIPTION OF THE FIGURES

FIG. 1 is a top plan view of one embodiment of a fuel cell tube of the present disclosure.

FIG. 2 is a side elevational view of the fuel cell tube of FIG. 1.

FIG. 3 is a front elevational cross-sectional view of the fuel cell tube of FIG. 1 taken substantially along line 3-3 of FIG. 1.

FIG. 4 is a side elevational cross-sectional view of part of one of the fuel cells of the fuel cell tube of FIG. 1 taken substantially along line 4-4 of FIG. 1.

FIG. 5 is a side elevational view of six fuel cell tubes of one embodiment of a fuel cell stack of the present disclosure.

FIG. 6 is a front elevational cross-sectional view of the fuel cell tubes of the fuel cell stack of FIG. 5 taken substantially along line 6-6 of FIG. 5.

FIG. 7 is a rear elevational cross-sectional view of the fuel cell tubes of the fuel cell stack of FIG. 5 taken substantially along line 7-7 of FIG. 5.

FIGS. 8A-8D are front elevational cross-sectional views of two prior art fuel cell tubes of a prior art fuel cell stack during resistance testing.

FIGS. 9A-9D are front elevational cross-sectional views of two the fuel cell tubes of the fuel cell stack of FIG. 5 during resistance testing taken substantially along line 6-6 of FIG. 5.

FIGS. 10A and 10B are schematics showing a side view of one embodiment of a fuel cell tube of the present disclosure along the length of the tube. FIG. 10A shows the anode side of the tube and FIG. 10B shows the cathode side of the tube.

FIGS. 11A and 11B are schematics showing a top view of one embodiment of a fuel cell tube of the present disclosure. FIGS. 11C and 11D are schematics showing a bottom view of one embodiment of a fuel cell tube of the present disclosure. FIGS. 11A and 11C show the anode side of the tube, and FIGS. 11B and 11D show the cathode side of the tube.

FIG. 12 is a top plan view of one embodiment of a fuel cell tube of the present disclosure.

FIG. 13 is a side elevational view of the fuel cell tube of FIG. 12.

FIG. 14A is a front elevational cross-sectional view of the fuel cell tube of FIG. 12 taken substantially along line 8-8 of FIG. 12. FIG. 14B is a front elevational cross-sectional view of the fuel cell tube of FIG. 12 taken substantially along line 9-9 of FIG. 12.

FIGS. 15A and 15B are front elevational cross-sectional views of three fuel cell tubes of one embodiment of a fuel cell stack of the present disclosure.

### DETAILED DESCRIPTION

While the features, methods, devices, and systems described herein may be embodied in various forms, the drawings show and the detailed description describes some exemplary and non-limiting embodiments. Not all of the components shown and described in the drawings and the detailed descriptions may be required, and some implementations may include additional, different, or fewer components from those expressly shown and described. Variations in the arrangement and type of the components; the shapes, sizes, and materials of the components; and the manners of attachment and connections of the components may be made without departing from the spirit or scope of the claims as set forth herein. This specification is intended to be taken as a whole and interpreted in accordance with the principles of the invention as taught herein and understood by one of ordinary skill in the art.

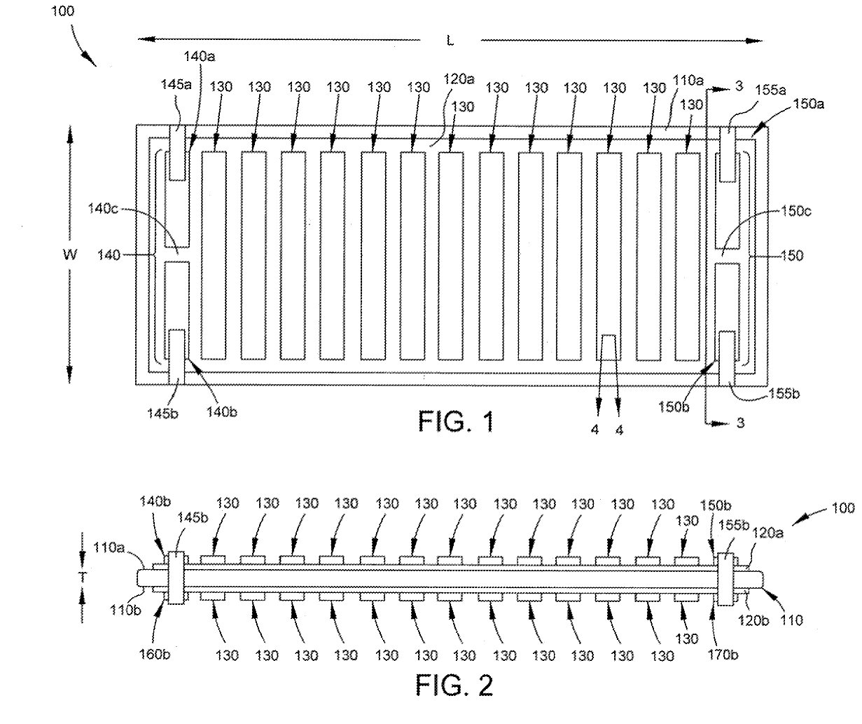

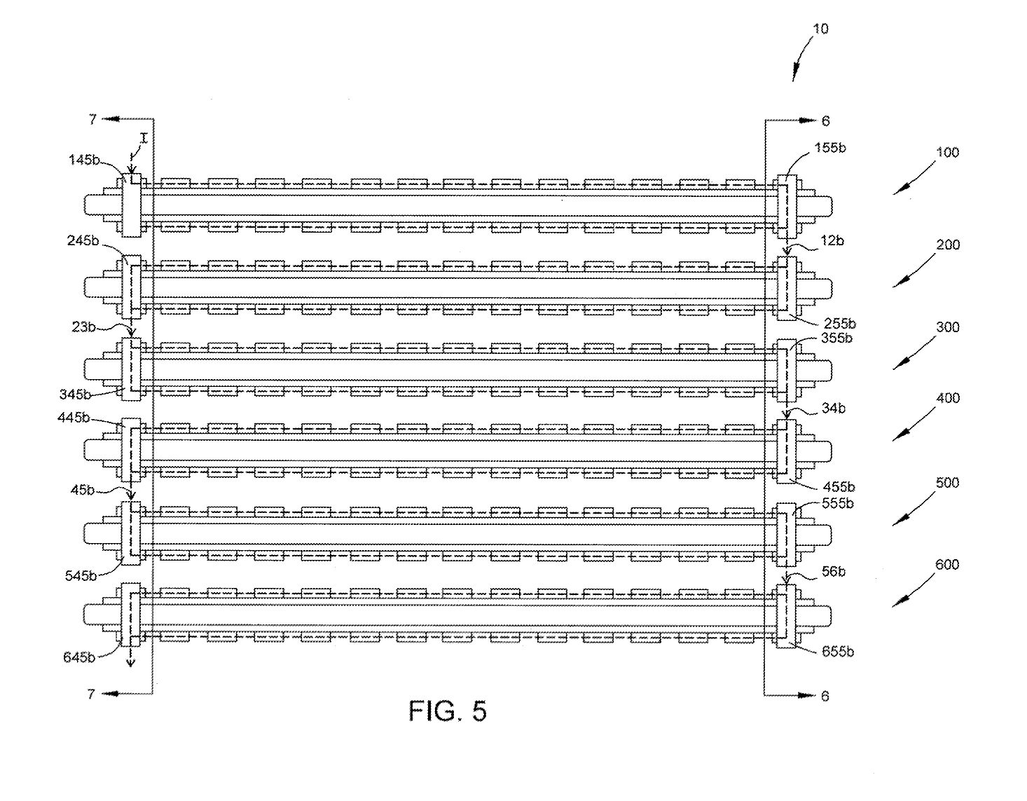

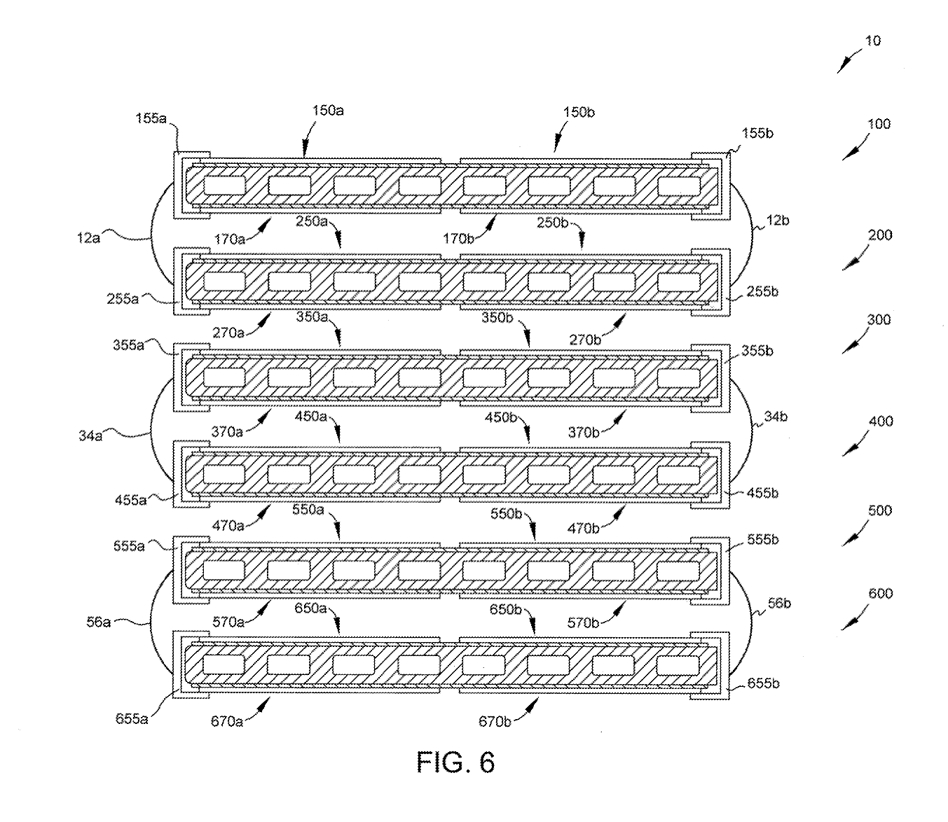

FIGS. 1-4 illustrate one example embodiment of a fuel cell tube 100 of the present disclosure and components thereof. FIGS. 5-7 illustrate part of one example embodiment of a fuel cell stack 10 of the present disclosure including the fuel cell tube 100 and fuel cell tubes 200, 300, 400, 500, and 600 electrically connected to one another.

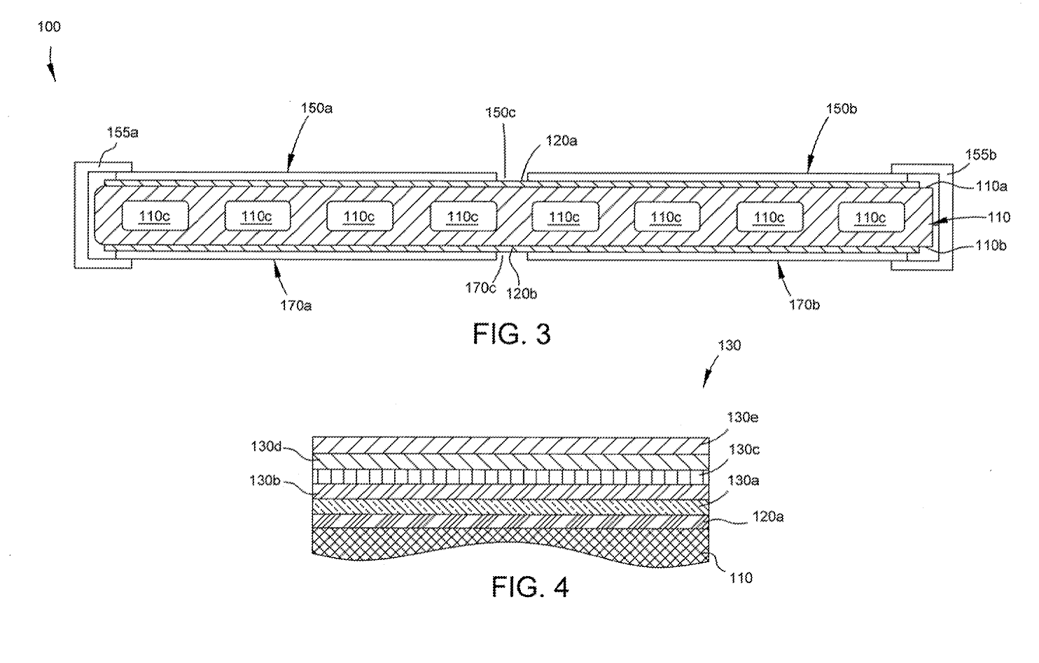

The fuel cell tube 100 includes a porous substrate 110 having a width W, a length L, a thickness T, a generally planar upper major surface 110a, and a generally planar lower major surface 110b. As shown in FIG. 3, multiple fuel conduits 110c extend through the substrate 110 along the length L of the substrate 110. The fuel cell tube 100 is fluidly connectable to a manifold (not shown) that is fluidly connectable to a fuel source such that fuel can flow from the fuel source through the manifold and into and through the fuel conduits 110c. In this example embodiment, the substrate 110 is formed of MgO—MgAl₂O₄ (MMA), though in other embodiments the substrate 110 may be formed of any suitable material(s) in addition to or instead of MMA (such as doped zirconia and/or forsterite).

First and second porous anode barriers 120a and 120b are disposed on the upper and lower major surfaces 110a and 110b, respectively, of the substrate 110. The first and second porous anode barriers 120a and 120b are configured to prevent reactions between the anodes of the fuel cells (described below) and the substrate 110, and are not configured to provide electrical conduction within a given fuel cell or between two fuel cells. Additionally, the first and second porous anode barriers 120a and 120b are not configured to partake in the electrochemical reactions that generate electrical power from the fuel. In this example embodiment, the first and second porous anode barriers 120a and 120b are formed of an inert porous ceramic material that is not an electronic conductor such as 3YSZ or another suitable doped zirconia, though in other embodiments the first and second porous anode barriers 120a and 120b may be formed of any suitable material(s) in addition to or instead of doped zirconia, such as SrZrO₃ or SrTiO₃-doped zirconia composite. In other embodiments, the fuel cell tube 100 does not include the first and second porous anode barriers 120a and 120b.

Multiple fuel cells 130, a first laterally segmented fuel cell 140, and a second laterally segmented fuel cell 150 are disposed on the first porous anode barrier 120a. Each fuel cell 130, the first laterally segmented fuel cell 140, and the second laterally segmented fuel cell 150 generally extend laterally in the direction of the width W of the substrate 110 and terminate in opposing first and second lateral ends (not labeled). The fuel cells 130 are positioned between the first and second laterally segmented fuel cells 140 and 150, which are generally positioned at opposing ends of the first porous anode barrier 120a in the direction of the length L of the substrate 110. The fuel cells 130, the first laterally segmented fuel cell 140, and the second laterally segmented fuel cell 150 on the first porous anode barrier 120a are electrically connected in series via primary interconnects (not shown).

As best shown in FIGS. 1 and 3, the first laterally segmented fuel cell 140 includes first and second fuel cell portions 140a and 140b. The first and second fuel cell portions 140a and 140b are laterally separated in the direction of the width W of the substrate 110 by a space 140c such that the first and second fuel cell portions 140a and 140b are electrically isolated such that there is no continuous electrical path in the fuel cell across the width of the fuel cell tube. Put differently, no continuous direct electrical path exists between the first and second fuel cell portions 140a and 140b in the direction of the width W of the substrate 110. In this example embodiment, the space 140c is 0.5 millimeters in the direction of the width W of the substrate 110, though the space 140c may be of any suitable size sufficient to ensure the first and second fuel cell portions 140a and 140b are electrically isolated.

As best shown in FIGS. 1 and 3, the second laterally segmented fuel cell 150 includes first and second fuel cell portions 150a and 150b. The first and second fuel cell portions 150a and 150b are laterally separated in the direction of the width W of the substrate 110 by a space 150c such that the first and second fuel cell portions 150a and 150b are electrically isolated such that there is no continuous electrical path in the fuel cell across the width of the fuel cell tube. Put differently, no continuous direct electrical path exists between the first and second fuel cell portions 150a and 150b in the direction of the width W of the substrate 110. In this example embodiment, the space 150c is 0.5 millimeters in the direction of the width W of the substrate 110, though the space 150c may be of any suitable size sufficient to ensure the first and second fuel cell portions 150a and 150b are electrically isolated.

Similarly, multiple fuel cells 130, a third laterally segmented fuel cell 160, and a fourth laterally segmented fuel cell 170 are disposed on the second porous anode barrier 120b. Each fuel cell 130, the third laterally segmented fuel cell 160, and the fourth laterally segmented fuel cell 170 generally extend laterally in the direction of the width W of the substrate 110. The fuel cells 130 are positioned between the third and fourth laterally segmented fuel cells 160 and 170, which are generally positioned at opposing ends of the second porous anode barrier 120b in the direction of the length L of the substrate 110. The fuel cells 130, the third laterally segmented fuel cell 160, and the fourth laterally segmented fuel cell 170 on the second porous anode barrier 120b are electrically connected in series via primary interconnects (not shown).

As best shown in FIGS. 1 and 3, the third laterally segmented fuel cell 160 includes first and second fuel cell portions 160a and 160b. The first and second fuel cell portions 160a and 160b are separated in the direction of the width W of the substrate 110 by a space 160c such that the first and second fuel cell portions 160a and 160b are electrically isolated such that there is no continuous electrical path in the fuel cell across the width of the fuel cell tube. Put differently, no continuous direct electrical path exists between the first and second fuel cell portions 160a and 160b in the direction of the width W of the substrate 110. In this example embodiment, the space 160c is 0.5 millimeters in the direction of the width W of the substrate 110, though the space 160c be of any suitable size sufficient to ensure the first and second fuel cell portions 160a and 160b are electrically isolated.

As best shown in FIGS. 1 and 3, the fourth laterally segmented fuel cell 170 includes first and second fuel cell portions 170a and 170b. The first and second fuel cell portions 170a and 170b are laterally separated in the direction of the width W of the substrate 110 by a space 170c such that the first and second fuel cell portions 170a and 170b are electrically isolated such that there is no continuous electrical path in the fuel cell across the width of the fuel cell tube. Put differently, no continuous direct electrical path exists between the first and second fuel cell portions 170a and 170b in the direction of the width W of the substrate 110. In this example embodiment, the space 170c is 0.5 millimeters in the direction of the width W of the substrate 110, though the space 170c be of any suitable size sufficient to ensure the first and second fuel cell portions 170a and 170b are electrically isolated.

As shown in FIG. 4, each fuel cell 130 and each fuel cell portion of each laterally segmented fuel cell 140, 150, 160, 170, 181, 190, and 191 includes an anode current collector 130a, an anode 130b, an electrolyte 130c, a cathode 130d, and a cathode current collector 130e. The anode 130b is disposed between the anode current collector 130a and the electrolyte 130c. The electrolyte 130c is disposed between the anode 130b and the cathode 130d. The cathode 130d is disposed between the electrolyte 130c and the cathode current collector 130e. The anode current collector 130a is electrically connected to the anode 130b, and the cathode current collector 130e is electrically connected to the cathode 130d. The anode and cathode current collectors 130a and 130e provide a higher electrical conductivity path for the transfer of electrons than is possible by the anode and cathode along.

In this example embodiment, the anode current collector 130a is an electrode conductive layer formed of a nickel cermet. Examples of suitable materials include Ni—YSZ (yttria doping in zirconia is 3-8 mol %); Ni—ScSZ (scandia doping is 4-10 mol %, preferably second doping for phase stability for 10 mol % scandia-ZrO₂); Ni-doped ceria (such as Gd or Sm doping); cermet of Ni and doped lanthanum chromite (such as Ca doping on A site and Zn doping on B site); cermet of Ni and doped strontium titanate (such as La doping on A site and Mn doping on B site) and/or La₁₋ₓSrₓMn_{y}Cr_{1-y}O₃. In other embodiments, the anode current collector may be formed of cermets based at least in part on one or more precious metals and/or one or more precious metal alloys in addition to retaining Ni content. Precious metals in the cermet may include, for example, Pt, Pd, Au, Ag, and/or alloys thereof. The ceramic phase may include, for example, an inactive non-electrically conductive phase, including, for example, YSZ, ScSZ, and/or one or more other inactive phases, e.g., having desired coefficients of thermal expansion (CTE) to control the CTE of the layer to match the CTE of the substrate 110 and the electrolyte 130c. In some embodiments, the ceramic phase may include Al₂O₃ and/or a spinel such as NiAl₂O₄, MgAl₂O₄, MgCr₂O₄, or NiCr₂O₄. In other embodiments, the ceramic phase may be electrically conductive, e.g., doped lanthanum chromite, doped strontium titanate, and/or one or more forms of LaSrMnCrO. One specific example of the anode current collector 130a material is 76.5% Pd, 8.5% Ni, 15% 3YSZ.

In this example embodiment, the anode 130b is formed of xNiO-(100-x)YSZ (x is from 55 to 75 in weight ratio), yNiO-(100-y)ScSZ (y is from 55 to 75 in weight ratio), NiO-gadolinia stabilized ceria (such as 55 wt % NiO-45 wt % GDC), and/or NiO samaria stabilized ceria. In other embodiments, the anode may be formed of doped strontium titanate, La₁₋ₓSrₓMn_{y}Cr_{1-y}O₃ (e.g., La_{0.75}Sr_{0.25}Mn_{0.5}Cr_{0.5}O₃) and/or other ceramic-based anode materials.

In this example embodiment, the electrolyte 130c is formed of a ceramic material. In some embodiments, the electrolyte 130c is formed of a proton and/or oxygen ion conducting ceramic. In other embodiments, the electrolyte 130c is formed of YSZ, such as 3YSZ and/or 8YSZ. In other embodiments, the electrolyte 130c is formed of ScSZ, such as 4ScSZ, 6ScSz, and/or 10ScSZ in addition to or in place of YSZ. In other embodiments, the electrolyte 130c may be formed of doped ceria and/or doped lanthanum gallate. The electrolyte 130c is essentially impervious to diffusion therethrough of the oxidant (e.g., air or O₂) and the fuel (e.g., H₂) flowed through or past the fuel cell tube 100, but enables diffusion of oxygen ions and/or protons, depending upon the particular embodiment and its application.

In this example embodiment, the cathode 130d is formed of a mixture of an electrochemically catalytic ceramic and an ionic phase. The electrochemically catalytic phase consists of at least one of LSM (La₁₋ₓSrₓMnO₃, x=0.1 to 0.3), La₁₋ₓSrₓFeO₃, (such as x=0.3), La₁₋ₓSrₓCo_{y}Fe_{1-y}O₃(such as La_{0.6}Sr_{0.4}Co_{0.2}Fe_{0.8}O₃) and/or Pr₁₋ₓSrₓMnO₃(such as Pr_{0.8}Sr_{0.2}MnO₃), although other materials may be employed. For example, in some embodiments, the cathode 130d is formed of Ruddlesden-Popper nickelates and La₁₋ₓCaₓMnO₃ (such as La_{0.8}Ca_{0.2}MnO₃) materials. The ionic phase may be YSZ containing from 3-8 mole percent yttria, or ScSZ containing 4-10 mole percent scandia and optionally a second dopant of Al, Y or ceria at minor content (about 1 mole percent) for high scandia stabilized zirconias (8-10ScSZ) to prevent formation of the rhombohedral phase. The electrochemically catalytic ceramic phase can comprise 40-60% by volume of the cathode.

In this example embodiment, the cathode current collector 130e is an electrode conductive layer formed of an electronically conductive ceramic and in many cases is similar in its chemistry to that of the electrochemically catalytic ceramic phase of the cathode. For example, a LSM+YSZ cathode will generally employ a LSM (La1-xSrxMnO3, x=0.1 to 0.3) cathode current collector. Other embodiments of the cathode current collector 130e may include at least one of LaNiₓFe₁₋ₓO₃ (such as LaNi_{0.6}Fe_{0.4}O₃), La₁₋ₓSrₓMnO₃ (such as La_{0.75}Sr_{0.25}MnO₃), doped lanthanum chromites (such as La₁₋ₓCaₓCrO_{3-δ}, x=0.15-0.3), and/or Pr₁₋ₓSrₓCoO₃, such as Pr_{0.8}Sr_{0.2}CoO₃. In other embodiments, the cathode current collector 130e may be formed of a precious metal cermet. The precious metals in the precious metal cermet may include, for example, Pt, Pd, Au, Ag, and/or alloys thereof. Non electrically conducting ceramic phase may also be included, for example, YSZ, ScSZ, and Al₂O₃, or other ceramic materials. One specific example of cathode current collector 130e material is 80 wt % Pd-20 wt % LSM.

In this example embodiment, the fuel cells 130 and the laterally segmented fuel cells 140, 150, 160, 170, 181, 190, and 191 are formed by depositing films/layers onto the upper and lower major surfaces 110a and 110b of the substrate 110, such as by screen printing and/or inkjet printing, to form the porous anode barriers, the primary interconnects, the anode current collectors, and anodes, the electrolytes, the cathodes, and the cathode current collectors. In other embodiments, the films/layers may be deposited by one or more other techniques in addition to or instead of screen printing and/or inkjet printing. In various embodiments, one or more firing/sintering cycles are performed subsequent to depositing one or more films/layers. Other embodiments may not require any firing/sintering for one or more films/layers deposition.

A first fuel cell connector 145a is electrically connected to (and electrically connects) the first fuel cell portion 140a of the first laterally segmented fuel cell 140 and the first fuel cell portion 160a of the third laterally segmented fuel cell 160. A second fuel cell connector 145b is electrically connected to (and electrically connects) the second fuel cell portion 140b of the first laterally segmented fuel cell 140 and the second fuel cell portion 160b of the third laterally segmented fuel cell 160. A third fuel cell connector 155a is electrically connected to (and electrically connects) the first fuel cell portion 150a of the second laterally segmented fuel cell 150 and the first fuel cell portion 170a of the fourth laterally segmented fuel cell 170. A fourth fuel cell connector 155b is electrically connected to (and electrically connects) the second fuel cell portion 150b of the second laterally segmented fuel cell 150 and the second fuel cell portion 170b of the fourth laterally segmented fuel cell 170.

In this example embodiment, the first fuel cell connector 145a is electrically connected to (and in this example embodiment contacts) the cathode current collectors of the first fuel cell portions 140a and 160a, and the second fuel cell connector 145b is electrically connected to (and in this example embodiment contacts) the cathode current collectors of the second fuel cell portions 140b and 160b. Since the first and second fuel cell portions 140a and 140b are electrically isolated and the first and second fuel cell portions 160a and 160b are electrically isolated, the first and second fuel cell connectors 145a and 145b are electrically isolated such that there is no continuous electrical path across the width W of the tube (substrate 110).

In this example embodiment, the third fuel cell connector 155a is electrically connected to (and in this example embodiment contacts) the cathode current collectors of the first fuel cell portions 150a and 170a, and the fourth fuel cell connector 155b is electrically connected to (and in this example embodiment contacts) the cathode current collectors of the second fuel cell portions 150b and 170b. Since the first and second fuel cell portions 150a and 150b are electrically isolated and the first and second fuel cell portions 170a and 170b are electrically isolated, the third and fourth fuel cell connectors 155a and 155b are electrically isolated such that there is no continuous electrical path across the width W of the tube (substrate 110).

FIGS. 5-7 show six fuel cell tubes 100, 200, 300, 400, 500, and 600 of the fuel cell stack 10. While the fuel cell stack 10 may include any suitable quantity of fuel cell tubes electrically connected to one another in series, only six are shown here for clarity and brevity. In this example embodiment, the fuel cell tubes 200, 300, 400, 500, and 600 are identical to the fuel cell tube 100 and are therefore not separately described (though in other embodiments the fuel cell tubes may differ from one another). The element numbering schemes of the fuel cell tubes 200, 300, 400, 500, and 600 correspond to the element numbering scheme used to describe the fuel cell tube 100 such that like element numbers correspond to like components.

The first fuel cell tube 100 is electrically connected to the second fuel cell tube 200 via: (1) a first tube interconnect 12a that electrically connects the third fuel cell connector 155a of the first fuel cell tube 100 to the third fuel cell connector 255a of the second fuel cell tube 200; and (2) a second tube interconnect 12b that electrically connects the fourth fuel cell connector 155b of the first fuel cell tube 100 to the fourth fuel cell connector 255b of the second fuel cell tube 200. Generally, the fuel cell tubes are connected in series with direction of the flow of fuel through the tubes.

The second fuel cell tube 200 is electrically connected to the third fuel cell tube 300 via: (1) a third tube interconnect 23a that electrically connects the first fuel cell connector 245a of the second fuel cell tube 200 to the first fuel cell connector 345a of the third fuel cell tube 300; and (2) a fourth tube interconnect 23b that electrically connects the second fuel cell connector 245b of the second fuel cell tube 200 to the second fuel cell connector 345b of the third fuel cell tube 300.

The third fuel cell tube 300 is electrically connected to the fourth fuel cell tube 400 via: (1) a fifth tube interconnect 34a that electrically connects the third fuel cell connector 355a of the third fuel cell tube 300 to the third fuel cell connector 455a of the fourth fuel cell tube 400; and (2) a sixth tube interconnect 34b that electrically connects the fourth fuel cell connector 355b of the third fuel cell tube 300 to the fourth fuel cell connector 455b of the fourth fuel cell tube 400.

The fourth fuel cell tube 400 is electrically connected to the fifth fuel cell tube 500 via: (1) a seventh tube interconnect 45a that electrically connects the first fuel cell connector 445a of the fourth fuel cell tube 400 to the first fuel cell connector 545a of the fifth fuel cell tube 500; and (2) a eighth tube interconnect 45b that electrically connects the second fuel cell connector 445b of the fourth fuel cell tube 400 to the second fuel cell connector 545b of the fifth fuel cell tube 500.

The fifth fuel cell tube 500 is electrically connected to the sixth fuel cell tube 600 via: (1) a ninth tube interconnect 56a that electrically connects the third fuel cell connector 555a of the fifth fuel cell tube 500 to the third fuel cell connector 655a of the sixth fuel cell tube 600; and (2) a tenth tube interconnect 56b that electrically connects the fourth fuel cell connector 555b of the fifth fuel cell tube 500 to the fourth fuel cell connector 655b of the sixth fuel cell tube 600.

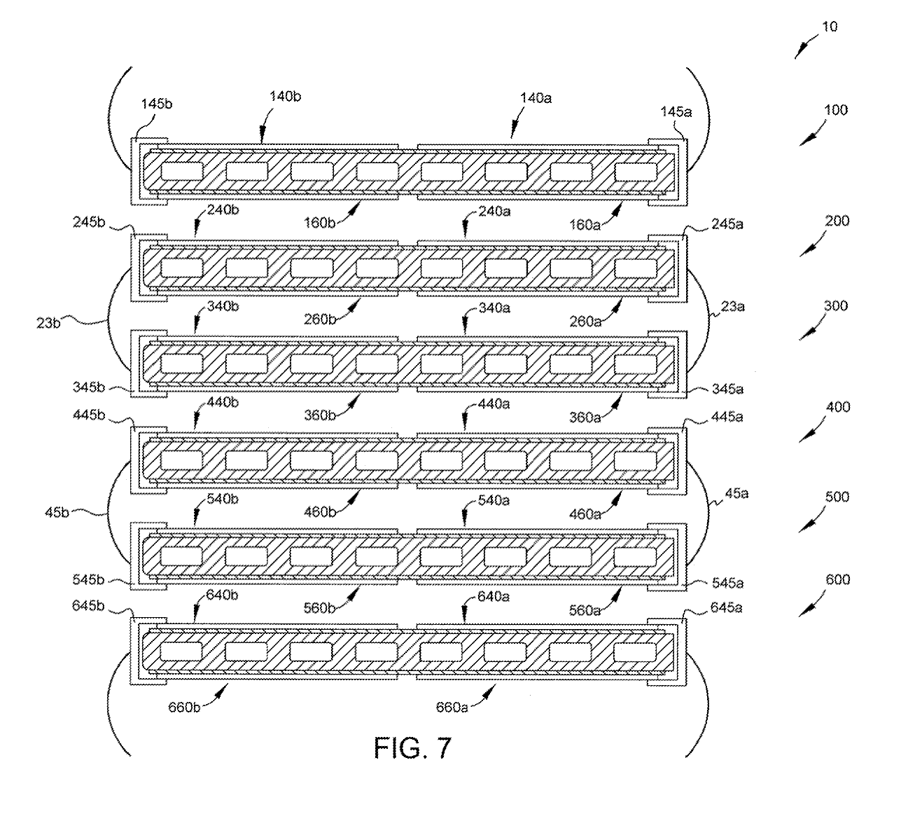

Although not shown here, the first fuel cell tube 100 may be electrically connected to another fuel cell tube of the fuel cell stack 10 or to another fuel cell stack via the tube interconnects shown but not labeled in FIGS. 5 and 7. Similarly, the sixth fuel cell tube 600 may be electrically connected to another fuel cell tube of the fuel cell stack 10 or to another fuel cell stack via the tube interconnects shown but not labeled in FIGS. 5 and 7.

In operation, as oxidant is flowed past the cathodes of the fuel cells of the fuel cell tubes and as fuel is flowed through the fuel conduits of the substrates of the fuel cell tubes, the electrochemical reactions that occur at the cathodes and the anodes produce free electrons at the anodes. Within a particular fuel cell tube, those free electrons flow as electrical current from one fuel cell to the next (via the anode current collectors, the primary interconnects, and the cathode current collectors) in a particular direction. Once the electrical current reaches the final fuel cell in the fuel cell tube (here, a laterally segmented fuel cell), the electrical current flows via the fuel cell connectors and the tube interconnects to the next fuel cell tube, and so on until reaching the electrical load.

For instance, as shown in FIG. 5, in this example embodiment, the electrical current I flows: (1) within the fuel cell tube 100 from the laterally segmented fuel cells 140 and 160 through the fuel cells 130 and to the laterally segmented fuel cells 150 and 170; (2) from the laterally segmented fuel cells 150 and 170 of the fuel cell tube 100 to the laterally segmented fuel cells 250 and 270 of the fuel cell tube 200 via the fuel cell connectors 155a, 155b, 255a, and 255b and the tube interconnects 12a and 12b; (3) within the fuel cell tube 200 from the laterally segmented fuel cells 250 and 270 through the fuel cells 230 and to the laterally segmented fuel cells 240 and 260; (4) from the laterally segmented fuel cells 240 and 260 of the fuel cell tube 200 to the fuel cells 340 and 360 of the fuel cell tube 300 via the fuel cell connectors 245a, 245b, 345a, and 345b and the tube interconnects 23a and 23b; (5) within the fuel cell tube 300 from the laterally segmented fuel cells 340 and 360 through the fuel cells 330 and to the laterally segmented fuel cells 350 and 370; (6) from the laterally segmented fuel cells 350 and 370 of the fuel cell tube 300 to the laterally segmented fuel cells 450 and 470 of the fuel cell tube 400 via the fuel cell connectors 355a, 355b, 455a, and 455b and the tube interconnects 34a and 34b; (7) within the fuel cell tube 400 from electrically isolated the fuel cells 450 and 470 through the fuel cells 430 and to the laterally segmented fuel cells 440 and 460; (8) from the laterally segmented fuel cells 440 and 460 of the fuel cell tube 400 to the laterally segmented fuel cells 540 and 560 of the fuel cell tube 500 via the fuel cell connectors 445a, 445b, 545a, and 545b and the tube interconnects 45a and 45b; (9) within the fuel cell tube 500 from the laterally segmented fuel cells 540 and 560 through the fuel cells 530 and to the laterally segmented fuel cells 550 and 570; (10) from the laterally segmented fuel cells 550 and 570 of the fuel cell tube 500 to the laterally segmented fuel cells 650 and 670 of the fuel cell tube 600 via the fuel cell connectors 555a, 555b, 655a, and 655b and the tube interconnects 56a and 56b; (11) within the fuel cell tube 600 from the laterally segmented fuel cells 650 and 670 through the fuel cells 630 and to the laterally segmented fuel cells 640 and 660; and (12) from the laterally segmented fuel cells 640 and 660 of the fuel cell tube 600 to the electrical load (or to another fuel cell tube or fuel cell stack) via the fuel cell connectors 645a and 645b.

For the fuel cell stack to conduct electrical current from one fuel cell tube to another, the tube interconnects must be in working order, i.e., provide a path for the electrical current to flow from one fuel cell tube to the other. One way of checking whether a given tube interconnect is in working order is by using an ohmmeter to attempt to flow an electrical current across that tube interconnect and to calculate the resistance across that tube interconnect. If the resistance is relatively low (e.g., negligible), the electrical current is able to flow across the tube interconnect. But if the resistance is relatively high (e.g., infinite), the electrical current is not able to flow across the tube interconnect, and the tube interconnect is damaged and must be repaired or replaced to ensure proper fuel cell stack operation.

Since prior art fuel cell tubes do not include laterally segmented fuel cells, their fuel cell connectors are electrically connected to laterally continuous fuel cells. As described below, this leads to ohmmeters generating false positive readings in certain instances when calculating the resistance across a particular tube interconnect. That is, in certain instances, the ohmmeter calculates a relatively low resistance across a given tube interconnect—and thus indicates a working tube interconnect—when in reality that tube interconnect is damaged such that it electrical current cannot flow through it.

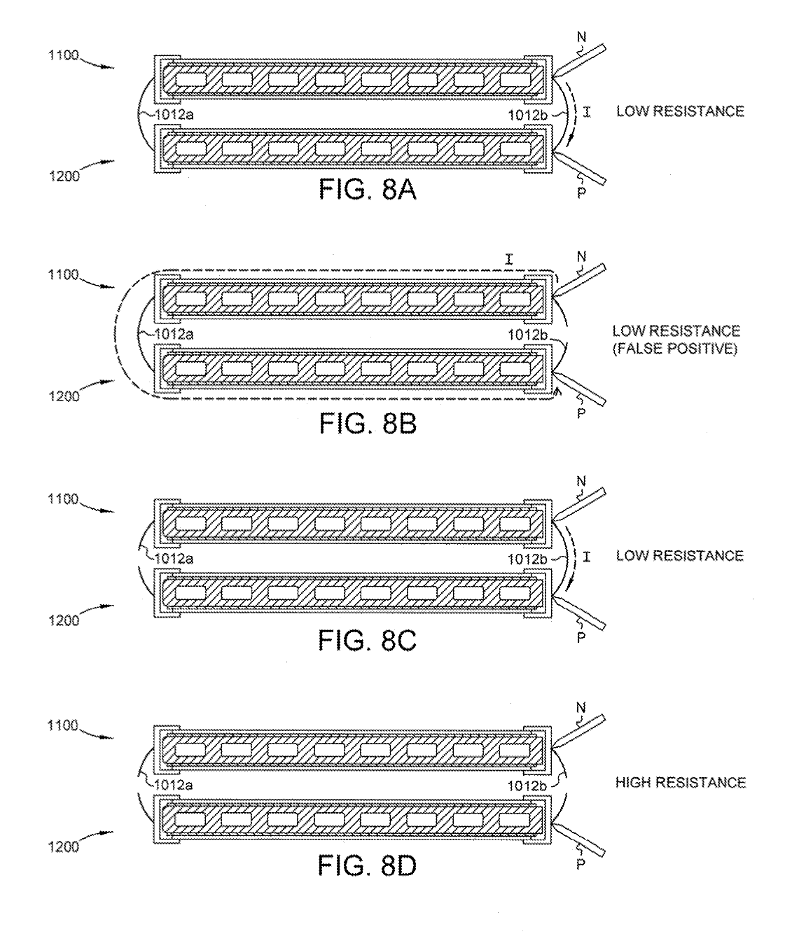

FIGS. 8A-8D show a negative ohmmeter probe N and a positive ohmmeter probe P positioned to attempt to flow an electrical current I across a tube interconnect 1012b that electrically connects prior art fuel cell tubes 1100 and 1200. Opposing tube interconnect 1012a also electrically connects the prior art fuel cells 1100 and 1200. The fuel cell connectors (not labeled) of the fuel cell tubes 1100 and 1200 are electrically connected to laterally continuous fuel cells.

In the scenario shown in FIG. 8A, the tube interconnects 1012a and 1012b are both in working order. The ohmmeter calculates a low resistance because the tube interconnect 1012b is in working order and the electrical current I can flow across the tube interconnect 1012b from the negative probe N to the positive probe P.

In the scenario shown in FIG. 8B, the tube interconnect 1012a is in working order while the tube interconnect 1012b is damaged such that electrical current cannot flow through it. But rather than calculate a high resistance that correspond to electrical current not being able to flow across the tube interconnect 1012b, the ohmmeter calculates a low resistance because the electrical current flows from the negative probe N across the laterally continuous fuel cells of the fuel cell tube 1100, across the tube interconnect 1012a, and across the laterally continuous fuel cells of the fuel cell tube 1200 to the positive probe P. In other words, the laterally continuous fuel cells provide a low-resistance path for the electrical current Ito flow from the negative probe N to the positive probe P, so the electrical current does so and causes the ohmmeter to calculate a low resistance that does not reflect the damaged state of the tube interconnect 1012b.

In the scenario shown in FIG. 8C, the tube interconnect 1012a is damaged such that electrical current cannot flow through it while the tube interconnect 1012b is in working order. The ohmmeter calculates a low resistance because the tube interconnect 1012b is in working order and the electrical current I can flow across the tube interconnect 1012b from the negative probe N to the positive probe P.

In the scenario shown in FIG. 8D, the tube interconnects 1012a and 1012b are damaged such that electrical current cannot flow through them. The ohmmeter calculates a high resistance because electrical current cannot flow through either of the tube interconnects 1012a or 1012b from the negative probe N to the positive probe P.

The fuel cell tubes with laterally segmented fuel cells of the present disclosure solve this problem. As explained above, the fuel cell connectors of the fuel cell tubes of the present disclosure are electrically connected to laterally segmented fuel cells, which means only one low-resistance electrical path exists when attempting to flow electrical current across a tube interconnect during resistance testing.

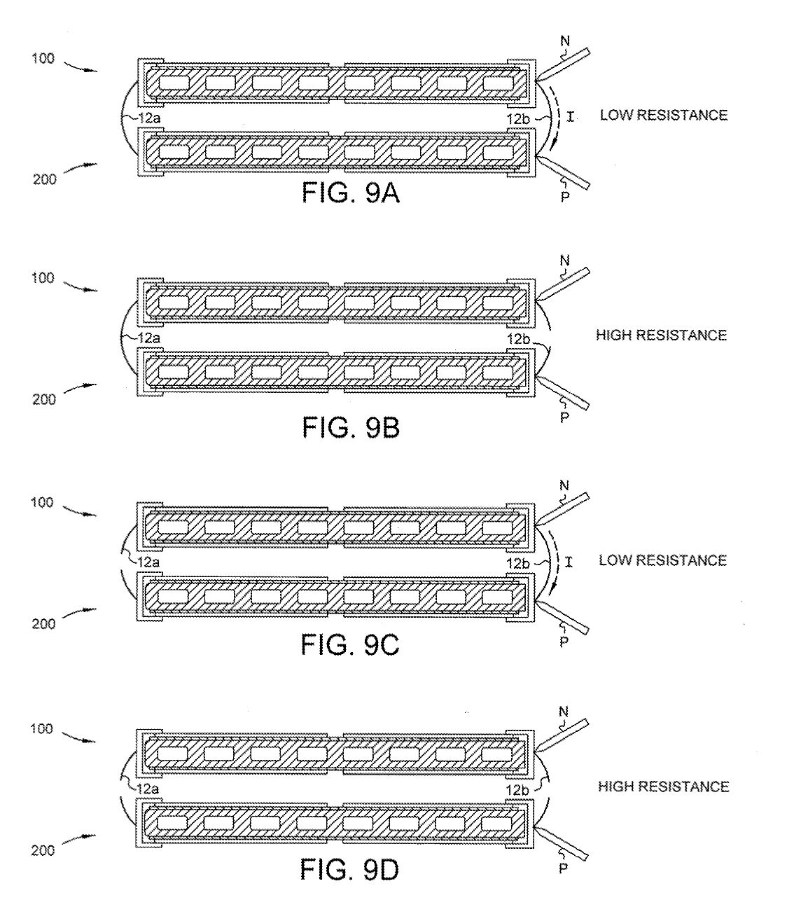

FIGS. 9A-9D show negative probe N and positive probe P of the ohmmeter described above positioned to attempt to flow an electrical current across the tube interconnect 12b.

In the scenario shown in FIG. 9A, the tube interconnects 12a and 12b are both in working order. The ohmmeter calculates a low resistance because the tube interconnect 12b is in working order and the electrical current I can flow across the tube interconnect 12b from the negative probe N to the positive probe P.

In the scenario shown in FIG. 9B, the tube interconnect 12a is in working order while the tube interconnect 12b is damaged such that electrical current cannot flow through it. The ohmmeter calculates a high resistance because electrical current cannot flow through the tube interconnect 12b from the negative probe N to the positive probe P. Additionally, electrical current cannot flow from the negative probe N to the positive probe P through the tube interconnect 12a because a low-resistance electrical path does not exist between the negative probe N and the positive probe P through the tube interconnect 12a due to the laterally segmented fuel cells.

In the scenario shown in FIG. 9C, the tube interconnect 12a is damaged such that electrical current cannot flow through it while the tube interconnect 12b is in working order. The ohmmeter calculates a low resistance because the tube interconnect 12b is in working order and the electrical current I can flow across the tube interconnect 12b from the negative probe N to the positive probe P.

In the scenario shown in FIG. 9D, the tube interconnects 12a and 12b are damaged such that electrical current cannot flow through them. The ohmmeter calculates a high resistance because electrical current cannot flow through either of the tube interconnects 12a or 12b from the negative probe N to the positive probe P.

Another benefit is that the use of laterally segmented fuel cells has a negligible effect on the performance of a given fuel cell tube because the electrical current density at the location of the space between the fuel cell portions is low because the electrical current is concentrated at the fuel cell connectors (through which the electrical current flows to the next fuel cell tube).

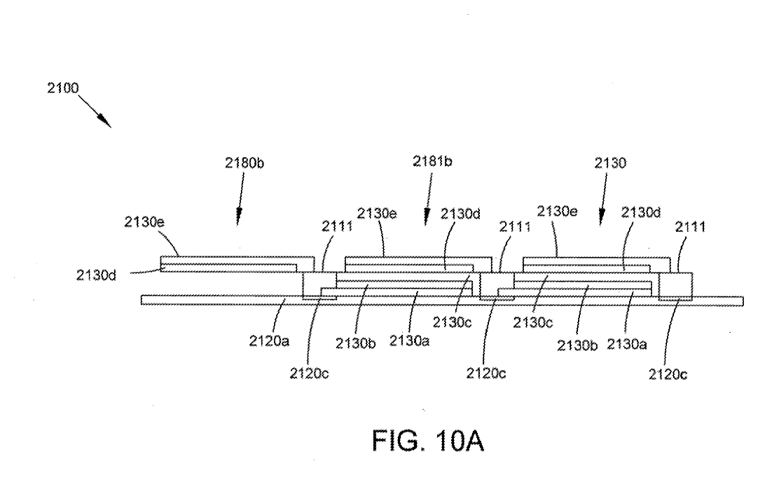

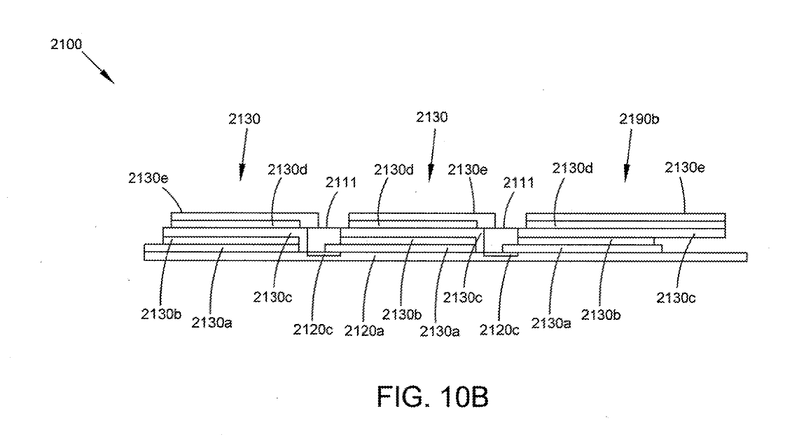

FIGS. 10A and 10B are schematics showing a side view of fuel cell tube 2100 along the length of the tube. FIG. 10A shows schematics of the anode-side of a fuel cell tube, including a tube interconnect connection region at laterally segmented dummy cell portion 2180b. Laterally segmented dummy cell portion 2180b includes cathode current collector 2130e and cathode 2130d. Laterally segmented dummy cell portion 2180b is electrically connected to a laterally segmented fuel cell portion 2181b by a primary interconnect within primary interconnect region 2111, which may overlay dense barrier 2120c. Dense barrier 2120c may be formed from yttria stabilized zirconia, preferably 3YSZ. Dense barrier 2120c could be formed of 8YSZ or ScSz as well and could have additional impurities, compositing to reduce its ionic conductivity. Dense barrier 2120c could also be formed of non-zirconia ceramics not having electrical conductivity. The lateral segmentation extends into the primary interconnect region 2111 connected to dummy cell 2180 and into the fuel cell 2181 to allow for electrical isolation of an operated fuel cell.

Laterally segmented fuel cell portion 2181b includes cathode current collector 2130e, cathode 2130d, electrolyte 2130c, anode 2130b, and anode current collector 2130a. The anode 2130b is disposed between the anode current collector 2130a and the electrolyte 2130c. The electrolyte 2130c is disposed between the anode 2130b and the cathode 2130d. The cathode 2130d is disposed between the electrolyte 2130c and the cathode current collector 2130e. The anode current collector 2130a is electrically connected to the anode 2130b, and the cathode current collector 2130e is electrically connected to the cathode 2130d. The anode current collector 2130a and cathode current collector 2130e provide a higher electrical conductivity path for the transfer of electrons than is possible by the anode and cathode alone. Laterally segmented fuel cell portion 2181b is electrically connected to fuel cell 2130 by a primary interconnect within primary interconnect region 2111, which may overlay dense barrier 2120c. Dense barrier 2120c may be formed from yttria stabilized zirconia, preferably 3YSZ. Dense barrier 2120c could be formed of 8YSZ or ScSz as well and could have additional impurities, compositing to reduce its ionic conductivity. Dense barrier 2120c could also be formed of non-zirconia ceramics not having electrical conductivity.

Fuel cell 2130 may be further electrically connected to other fuel cells 2130 by a primary interconnect within primary interconnect region 2111. Porous anode barrier 2120a is printed over the upper major surface 2110a (not shown) of the tube 2100 and overlaid by laterally segmented dummy cell portion 2180b, laterally segmented fuel cell portion 2181b, fuel cell 2130, primary interconnect regions 2111, and optional dense barrier 2120c. Fuel passes through the porous anode barrier 2120a to reach the active cell.

In fuel cell 2130 and laterally segmented fuel cell portion 2181b, the anode 2130b is disposed between the anode current collector 2130a and the electrolyte 2130c. The electrolyte 2130c is disposed between the anode 2130b and the cathode 2130d. The cathode 2130d is disposed between the electrolyte 2130c and the cathode current collector 2130e. The anode current collector 2130a is electrically connected to the anode 2130b, and the cathode current collector 2130e is electrically connected to the cathode 2130d. The anode current collector 2130a and cathode current collector 2130e provide a higher electrical conductivity path for the transfer of electrons than is possible by the anode and cathode alone.

FIG. 10B shows schematics of the cathode-side of fuel cell tube 2100, including a tube interconnect connection region at laterally segmented fuel cell portion 2190b. Laterally segmented fuel cell portion 2190b includes cathode current collector 2130e, cathode 2130d, electrolyte 2130c, anode 2130b, and anode current collector 2130a, where the cathode current collector 2130e, cathode 2130d, and electrolyte 2130c extend past anode 2130b and anode current collector 2130a into the tube interconnect connection region. The anode 2130b is disposed between the anode current collector 2130a and the electrolyte 2130c. The electrolyte 2130c is disposed between the anode 2130b and the cathode 2130d. The cathode 2130d is disposed between the electrolyte 2130c and the cathode current collector 2130e. The anode current collector 2130a is electrically connected to the anode 2130b, and the cathode current collector 2130e is electrically connected to the cathode 2130d. The anode current collector 2130a and cathode current collector 2130e provide a higher electrical conductivity path for the transfer of electrons than is possible by the anode and cathode alone. Laterally segmented fuel cell portion 2190b may be further electrically connected to fuel cell 2130 by a primary interconnect within primary interconnect region 2111, which may overlay dense barrier 2120c. Dense barrier 2120c may be formed from yttria stabilized zirconia, preferably 3YSZ. Dense barrier 2120c could be formed of 8YSZ or ScSz as well and could have additional impurities, compositing to reduce its ionic conductivity.

Fuel cell 2130 may be further electrically connected to other fuel cells 2130 by a primary interconnect within primary interconnect region 2111, which may overlay dense barrier 2120c. Porous anode barrier 2120a is printed over the upper major surface 2110a (not shown) of the tube 2100 and overlaid by laterally segmented fuel cell portion 2190b, fuel cells 2130, primary interconnect regions 2111, and optional dense barrier 2120c. Fuel passes through the porous anode barrier 2120a to reach the active cell.

In this example embodiment, the anode current collector 2130a is an electrode conductive layer formed of a nickel cermet. Examples of suitable materials include Ni—YSZ (yttria doping in zirconia is 3-8 mol %); Ni—ScSZ (scandia doping is 4-10 mol %, preferably second doping for phase stability for 10 mol % scandia-ZrO₂); Ni-doped ceria (such as Gd or Sm doping); cermet of Ni and doped lanthanum chromite (such as Ca doping on A site and Zn doping on B site); cermet of Ni and doped strontium titanate (such as La doping on A site and Mn doping on B site) and/or La₁₋ₓSrₓMn_{y}Cr_{1-y}O₃. In other embodiments, the anode current collector may be formed of cermets based at least in part on one or more precious metals and/or one or more precious metal alloys in addition to retaining Ni content. Precious metals in the cermet may include, for example, Pt, Pd, Au, Ag, and/or alloys thereof. The ceramic phase may include, for example, an inactive non-electrically conductive phase, including, for example, YSZ, ScSZ, and/or one or more other inactive phases, e.g., having desired coefficients of thermal expansion (CTE) to control the CTE of the layer to match the CTE of the substrate 2110 and the electrolyte 2130c. In some embodiments, the ceramic phase may include Al₂O₃ and/or a spinel such as NiAl₂O₄, MgAl₂O₄, MgCr₂O₄, or NiCr₂O₄. In other embodiments, the ceramic phase may be electrically conductive, e.g., doped lanthanum chromite, doped strontium titanate, and/or one or more forms of LaSrMnCrO. One specific example of the anode current collector 2130a material is NiO—NiAl₂O₄-8YSZ.

In this example embodiment, the anode 2130b is formed of xNiO-(100-x)YSZ (x is from 55 to 75 in weight ratio), yNiO-(100-y)ScSZ (y is from 55 to 75 in weight ratio), NiO-gadolinia stabilized ceria (such as 55 wt % NiO-45 wt % GDC), and/or NiO samaria stabilized ceria. In other embodiments, the anode 2130b may be formed of doped strontium titanate, La₁₋ₓSrₓMn_{y}Cr_{1-y}O₃(e.g., La_{0.75}Sr_{0.25}Mn_{0.5}Cr_{0.5}O₃) and/or other ceramic-based anode materials.

In this example embodiment, the electrolyte 2130c is formed of a ceramic material. In some embodiments, the electrolyte 2130c is formed of a proton and/or oxygen ion conducting ceramic. In other embodiments, the electrolyte 2130c is formed of YSZ, such as 3YSZ and/or 8YSZ. In other embodiments, the electrolyte 2130c is formed of ScSZ, such as 4ScSZ, 6ScSz, and/or 10ScSZ in addition to or in place of YSZ. In other embodiments, the electrolyte 2130c may be formed of doped ceria and/or doped lanthanum gallate. The electrolyte ₂₁₃₀c is essentially impervious to diffusion therethrough of the oxidant (e.g., air or O₂) and the fuel (e.g., H₂) flowed through or past the fuel cell tube 2100, but enables diffusion of oxygen ions and/or protons, depending upon the particular embodiment and its application.

In this example embodiment, the cathode 2130d is formed of a mixture of an electrochemically catalytic ceramic and an ionic phase. The electrochemically catalytic phase consists of at least one of LSM (La₁₋ₓSrₓMnO₃, x=0.1 to 0.3), La₁₋ₓSrₓFeO₃, (such as x=0.3), La₁₋ₓSrₓCo_{y}Fe_{1-y}O₃ (such as La_{0.6}Sr_{0.4}Co_{0.2}Fe_{0.8}O₃) and/or Pr₁₋ₓSrₓMnO₃ (such as Pr_{0.8}Sr_{0.2}MnO₃), although other materials may be employed. For example, in some embodiments, the cathode 2130d is formed of Ruddlesden-Popper nickelates and La₁₋ₓCaₓMnO₃ (such as La_{0.8}Ca_{0.2}MnO₃) materials. The ionic phase may be YSZ containing from 3-8 mole percent yttria, or ScSZ containing 4-10 mole percent scandia and optionally a second dopant of Al, Y or ceria at minor content (about 1 mole percent) for high scandia stabilized zirconias (8-10ScSZ) to prevent formation of the rhombohedral phase. The electrochemically catalytic ceramic phase can comprise 40-60% by volume of the cathode.

In this example embodiment, the cathode current collector 2130e is an electrode conductive layer formed of an electronically conductive ceramic and in many cases is similar in its chemistry to that of the electrochemically catalytic ceramic phase of the cathode. For example, a LSM+YSZ cathode will generally employ a LSM (La1-xSrxMnO3, x=0.1 to 0.3) cathode current collector. Other embodiments of the cathode current collector 2130e may include at least one of LaNiₓFe₁₋ₓO₃ (such as LaNi_{0.6}Fe_{0.4}O₃), La₁₋ₓSrₓMnO₃ (such as La_{0.75}Sr_{0.25}MnO₃), doped lanthanum chromites (such as La₁₋ₓCaₓCrO_{3-δ}, x=0.15-0.3), and/or Pr₁₋ₓSrₓCoO₃, such as Pr_{0.8}Sr_{0.2}CoO₃. In other embodiments, the cathode current collector 2130e may be formed of a precious metal cermet. The precious metals in the precious metal cermet may include, for example, Pt, Pd, Au, Ag, and/or alloys thereof. Non electrically conducting ceramic phase may also be included, for example, YSZ, ScSZ, and Al₂O₃, or other ceramic materials. One specific example of cathode current collector 2130e material is (La0.8Sr0.2)0.95MnOx.

In this example embodiment, the fuel cells 2130, laterally segmented dummy cells 2180 and 2185, and the laterally segmented fuel cells 2181, 2186, 2190, and 2195 are formed by depositing films/layers onto the upper and lower major surfaces 2110a and 2110b of the substrate 2110, such as by screen printing and/or inkjet printing, to form the porous anode barriers, the primary interconnects, the anode current collectors, and anodes, the electrolytes, the cathodes, and the cathode current collectors. In other embodiments, the films/layers may be deposited by one or more other techniques in addition to or instead of screen printing and/or inkjet printing. In various embodiments, one or more firing/sintering cycles are performed subsequent to depositing one or more films/layers. Other embodiments may not require any firing/sintering for one or more films/layers deposition.

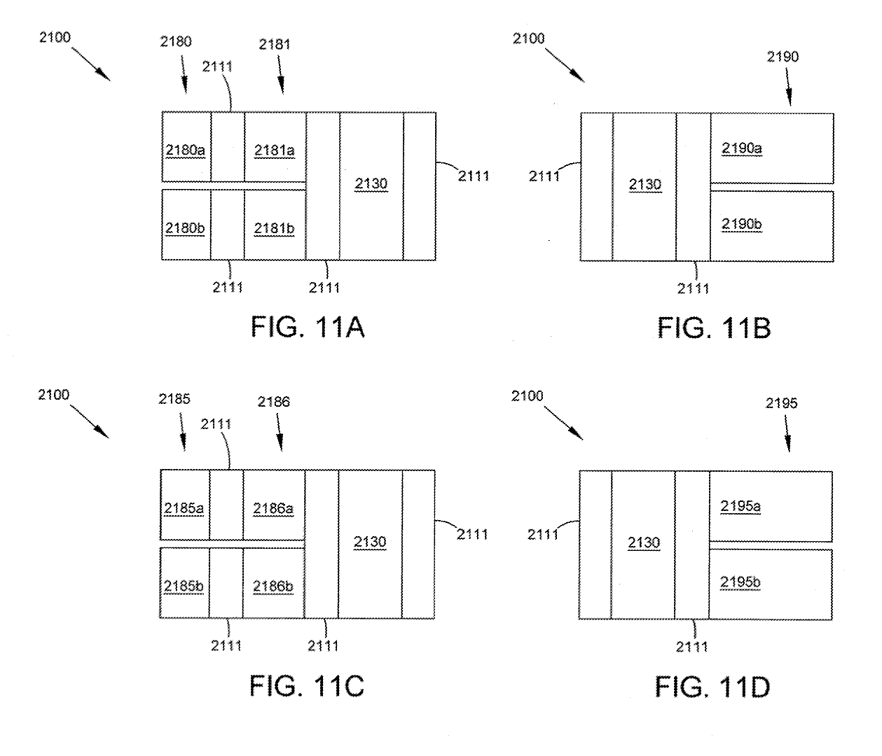

FIGS. 11A and 11B are schematics showing a top view of fuel cell tube 2100. FIG. 11A shows schematics of the anode-side of a fuel cell tube, including tube interconnect connection regions at laterally segmented dummy cell portions 2180a and 2180b. Laterally segmented dummy cell portions 2180a and 2180b are electrically connected to laterally segmented fuel cell portions 2181a and 2181b, respectively, via primary interconnects within laterally spaced primary interconnect regions 2111. The primary interconnect regions 2111 between the laterally segmented dummy cell portions and the laterally segmented fuel cell portions are laterally separated. The lateral segmentation extends into the primary interconnect region 2111 connected to dummy cell 2180 and into the fuel cell 2181 to allow for electrical isolation of an operated fuel cell. Laterally segmented fuel cell portions 2181a and 2181b are electrically connected to fuel cell 2130 via a primary interconnect within primary interconnect region 2111. Fuel cell 2130 may be further electrically connected to fuel cells 2130 via a primary interconnect within primary interconnect region 2111.

FIG. 11B shows schematics of the cathode-side of a fuel cell tube, including tube interconnect connection regions at laterally segmented fuel cell portions 2190a and 2190b. Laterally segmented fuel cell portions 2190a and 2190b are electrically connected to fuel cell 2130, via a primary interconnect within primary interconnect region 2111. Fuel cell 2130 may be further electrically connected to fuel cells 2130 (not shown) by a primary interconnect within primary interconnect region 2111.

The addition of a laterally segmented fuel cell 2181 connected to laterally segmented dummy cell 2180 on the anode-side of the fuel cell tube allows for the inspection of the side-to-side and tube-to-tube connections for cells that have been operated and have reduced anodes in the Ni-cermet highly conductive state. These additions prevent false readings when the cells are fired and there is a broken tube interconnect.

FIGS. 11C and 11D are schematics showing a bottom view of fuel cell tube 2100. FIG. 11C shows schematics of the anode-side of a fuel cell tube, including tube interconnect connection regions at laterally segmented dummy cell portions 2185a and 2185b. Laterally segmented dummy cell portions 2185a and 2185b are electrically connected to laterally segmented fuel cell portions 2186a and 2186b, respectively, via primary interconnects within primary interconnect regions 2111. The primary interconnect regions 2111 between the laterally segmented dummy cell portions and the laterally segmented fuel cell portions are laterally separated. The lateral segmentation extends into the primary interconnect region 2111 connected to dummy cell 2185 and into the fuel cell 2186 to allow for electrical isolation of an operated fuel cell. Laterally segmented fuel cell portions 2186a and 2186b are electrically connected to fuel cell 2130 via a primary interconnect within primary interconnect region 2111. Fuel cell 2130 may be further electrically connected to fuel cells 2130 via a primary interconnect within primary interconnect region 2111.

FIG. 11D shows schematics of the cathode-side of fuel cell tube 2100, including tube interconnect connection regions at laterally segmented fuel cell portions 2195a and 2195b. Laterally segmented fuel cell portions 2195a and 2195b are electrically connected to fuel cell 2130, via a primary interconnect within primary interconnect region 2111. Fuel cell 2130 may be further electrically connected to fuel cells 2130 (not shown) by a primary interconnect within primary interconnect region 2111.

The addition of a laterally segmented fuel cell 2186 connected to laterally segmented dummy cell 2185 on the anode-side of the fuel cell tube allows for the inspection of the side-to-side and tube-to-tube connections for cells that have been operated and have reduced anodes in the Ni-cermet highly conductive state. These additions prevent false readings when the cells are fired and there is a broken tube interconnect.

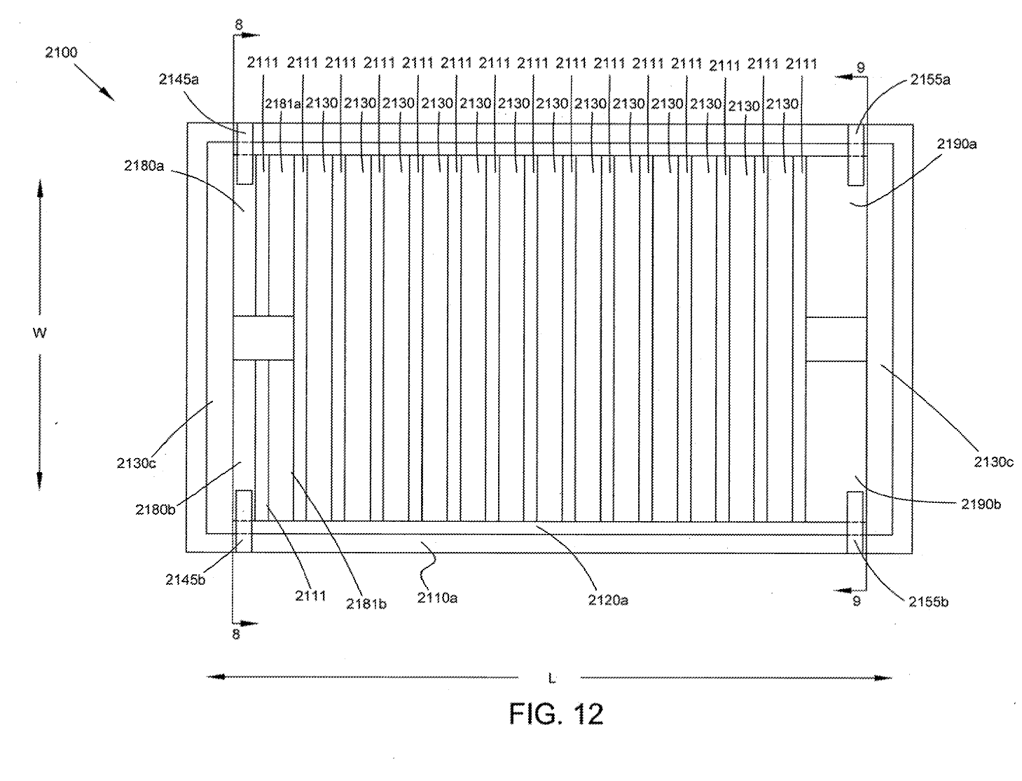

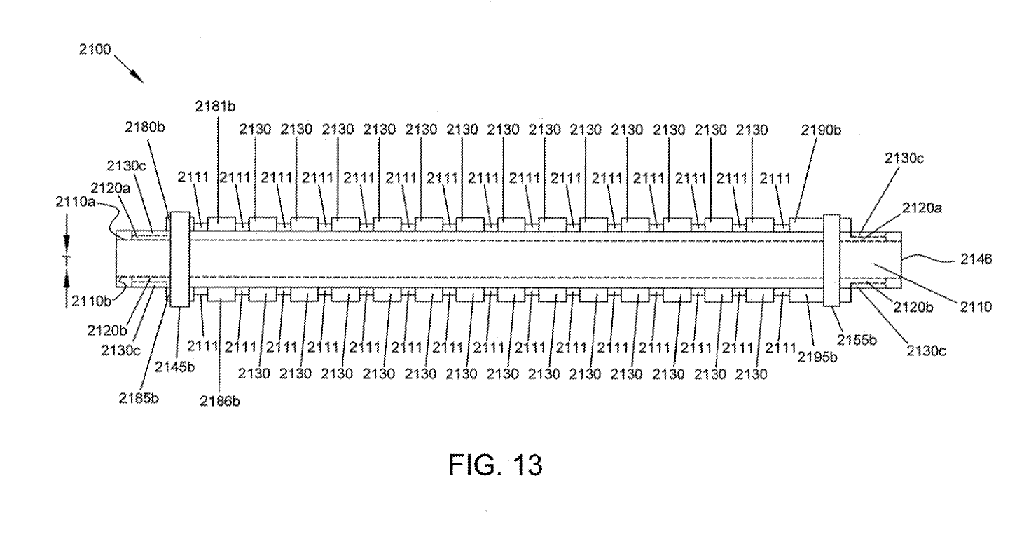

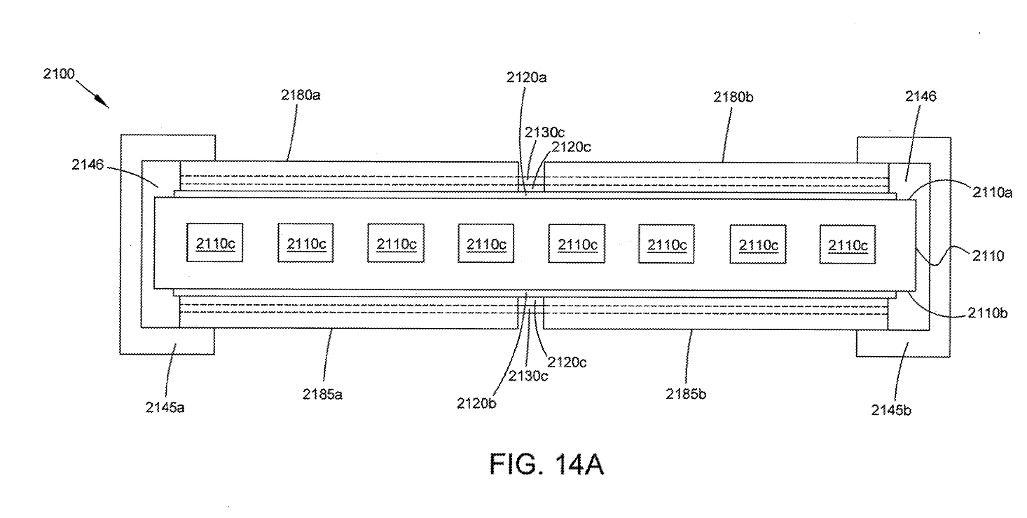

FIGS. 10-14 illustrate one example embodiment of a fuel cell tube 2100 of the present disclosure and components thereof. The fuel cell tube 2100 includes a porous substrate 2110 having a width W, a length L, a thickness T, a generally planar upper major surface 2110a, and a generally planar lower major surface 2110b. The fuel cell tube 2100 is fluidly connectable to a manifold (not shown) that is fluidly connectable to a fuel source such that fuel can flow from the fuel source through the manifold and into and through fuel conduits 2110c. In this example embodiment, the substrate 2110 is formed of MgO—MgAl₂O₄ (MMA), though in other embodiments the substrate 2110 may be formed of any suitable material(s) in addition to or instead of MMA (such as doped zirconia and/or forsterite). Glass edge seal 2146 is not shown in FIG. 12 in order to clarify the structure of components underneath it. In FIG. 13, electrolyte 2130c, first and second porous anode barriers 2120a and 2120b, and substrate 2110 are represented by dashed lines as they are behind the glass edge seal 2146.

First and second porous anode barriers 2120a and 2120b are disposed on the upper and lower major surfaces 2110a and 2110b, respectively, of the substrate 2110. The first and second porous anode barriers 2120a and 2120b are configured to prevent reactions between the anodes of the fuel cells (described below) and the substrate 2110, and are not configured to provide electrical conduction within a given fuel cell or between two fuel cells. Additionally, the first and second porous anode barriers 2120a and 2120b are not configured to partake in the electrochemical reactions that generate electrical power from the fuel. In this example embodiment, the first and second porous anode barriers 2120a and 2120b are formed of an inert porous ceramic material such as 3YSZ or another suitable doped zirconia, though in other embodiments the first and second porous anode barriers 2120a and 2120b may be formed of any suitable material(s) in addition to or instead of doped zirconia, such as SrZrO₃. In other embodiments, the fuel cell tube 2100 does not include the first and second porous anode barriers 2120a and 2120b.

Multiple fuel cells 2130, laterally segmented dummy cell 2180, and laterally segmented fuel cells 2181 and 2190 are disposed on the first porous anode barrier 2120a. Each fuel cell 2130, laterally segmented dummy cell 2180, and laterally segmented fuel cells 2181 and 2190 generally extend laterally in the direction of the width W of the substrate 2110 and terminate in opposing first and second lateral ends (not labeled). The fuel cells 2130 are positioned between laterally segmented fuel cells 2181 and 2190, which are generally positioned proximate opposing ends of the first porous anode barrier 2120a in the direction of the length L of the substrate 2110. The fuel cells 2130, the laterally segmented dummy cell 2180, and the laterally segmented fuel cells 2181 and 2190 on the first porous anode barrier 2120a are electrically connected in series via primary interconnects within primary interconnect regions 2111.

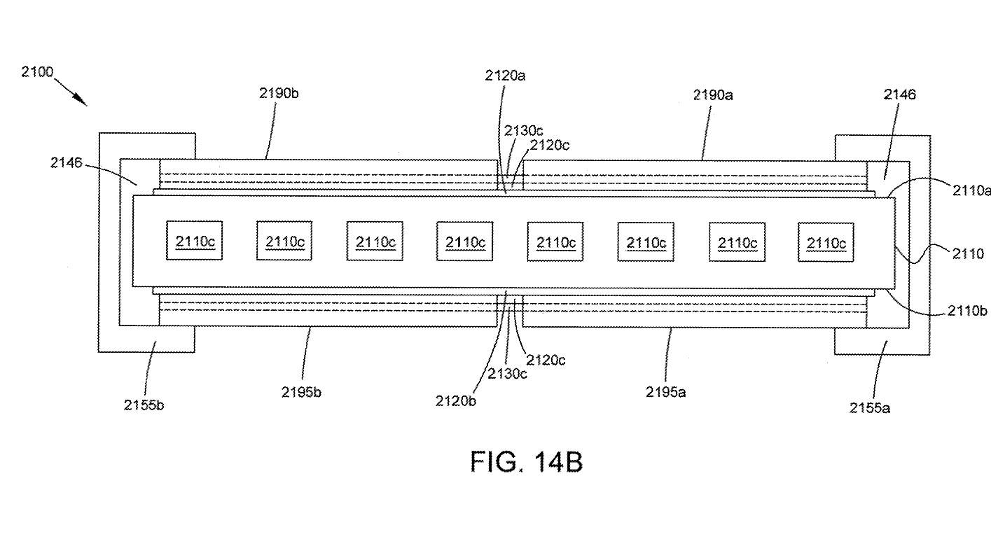

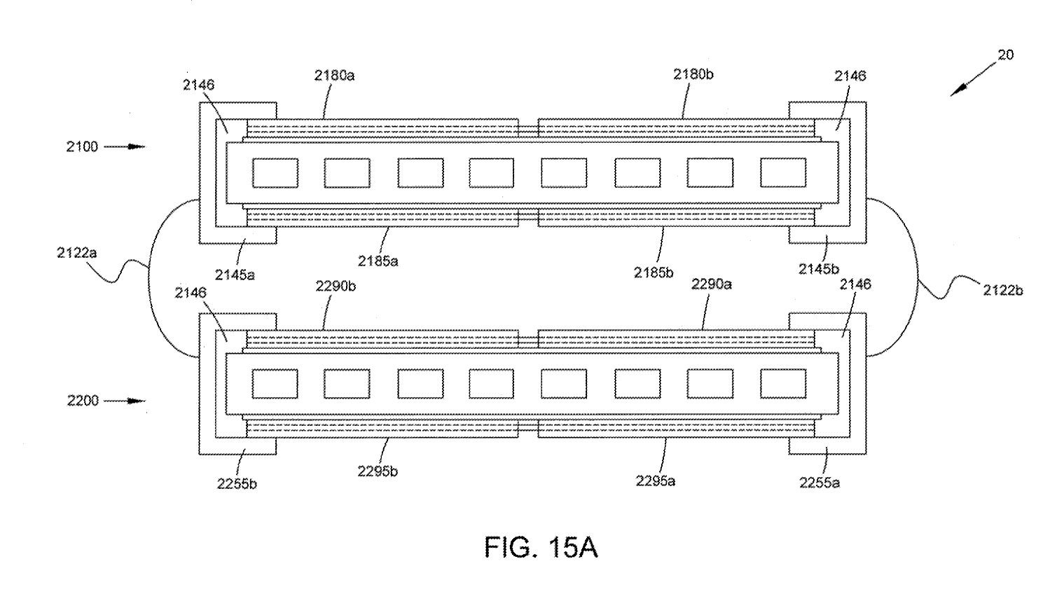

As best shown in FIGS. 11A and 12, the laterally segmented dummy cell 2180 includes first and second dummy cell portions 2180a and 2180b. First and second dummy cell portions 2180a and 2180b are electrically connected to first and second fuel cell portions 2181a and 2181b, respectively, via primary interconnects within primary interconnect regions 2111. The first and second dummy cell portions 2180a and 2180b are laterally separated in the direction of the width W of the substrate 2110 such that the first and second dummy cell portions are electrically isolated. No continuous direct electrical path exists between the dummy cell portions 2180a and 2180b, which are separated by a space of 1.5 mm in the direction of the width W of the substrate 2110. The primary interconnect regions 2111, which dummy cell portions 2180a and 2180b are connected to, are also separated by a space of 1.5 mm in the direction of the width W of the substrate 2110. As shown in FIG. 14A, the space between first and second dummy cell portions 2180a and 2180b includes dense barrier 2120c overlaid by electrolyte 2130c.

As best shown in FIGS. 11A and 12, the interior laterally segmented fuel cell 2181 includes first and second fuel cell portions 2181a and 2181b. First and second fuel cell portions 2181a and 2181b are electrically connected to fuel cell 2130 via a primary interconnect within primary interconnect region 2111. The first and second fuel cell portions 2181a and 2181b are laterally separated in the direction of the width W of the substrate 2110 such that the first and second fuel cell portions are electrically isolated. No continuous direct electrical path exists between the fuel cell portions 2181a and 2181b, which are separated by a space of 1.5 mm in the direction of the width W of the substrate 2110.

As best shown in FIGS. 11B and 12, the laterally segmented fuel cell 2190 includes first and second fuel cell portions 2190a and 2190b. First and second fuel cell portions 2190a and 2190b are electrically connected to fuel cell 2130 via a primary interconnect within primary interconnect region 2111. The first and second fuel cell portions 2190a and 2190b are laterally separated in the direction of the width W of the substrate 2110 such that the first and second fuel cell portions are electrically isolated. No continuous direct electrical path exists between the fuel cell portions 2190a and 2190b, which are separated by a space of 1.5 mm in the direction of the width W of the substrate 2110. As shown in FIG. 14B, the space between fuel cell portions 2190a and 2190b includes dense barrier 2120c overlaid by electrolyte 2130c.

Multiple fuel cells 2130, laterally segmented dummy cell 2185, and laterally segmented fuel cells 2186 and 2195 are disposed on the second porous anode barrier 2120b. Each fuel cell 2130, laterally segmented dummy cell 2185, and laterally segmented fuel cells 2186 and 2195 generally extend laterally in the direction of the width W of the substrate 2110. The fuel cells 2130 are positioned between laterally segmented fuel cells 2186 and 2195, which are generally positioned proximate opposing ends of the second porous anode barrier 2120b in the direction of the length L of the substrate 2110. The fuel cells 2130, the laterally segmented dummy cell 2185, and the laterally segmented fuel cells 2186 and 2195 on the second porous anode barrier 2120b are electrically connected in series via primary interconnects within primary interconnect regions 2111.

As best shown in FIGS. 11C and 14A, the laterally segmented dummy cell 2185 includes first and second dummy cell portions 2185a and 2185b. First and second dummy cell portions 2185a and 2185b are electrically connected to first and second fuel cell portions 2186a and 2186b, respectively, via primary interconnects within primary interconnect regions 2111. The first and second dummy cell portions 2185a and 2185b are laterally separated in the direction of the width W of the substrate 2110 such that the first and second dummy cell portions 2185a and 2185b are electrically isolated. No continuous direct electrical path exists between the first and second dummy cell portions 2185a and 2185b, which are separated by a space of 1.5 mm in the direction of the width W of the substrate 2110. The primary interconnect regions 2111, which dummy cell portions 2185a and 2185b are connected to, are also separated by a space of 1.5 mm in the direction of the width W of the substrate 2110. As shown in FIG. 14A, the space between dummy cell portions 2185a and 2185b includes dense barrier 2120c overlaid by electrolyte 2130c.

As best shown in FIG. 11C, the interior laterally segmented fuel cell 2186 includes first and second fuel cell portions 2186a and 2186b. First and second fuel cell portions 2186a and 2186b are electrically connected to fuel cell 2130 via a primary interconnect within primary interconnect region 2111. The first and second fuel cell portions 2186a and 2186b are laterally separated in the direction of the width W of the substrate 2110 such that the first and second fuel cell portions 2186a and 2186b are electrically isolated. No continuous direct electrical path exists between the first and second fuel cell portions 2186a and 2186b, which are separated by a space of 1.5 mm in the direction of the width W of the substrate 2110.

As best shown in FIGS. 11D and 14B the laterally segmented fuel cell 2195 includes first and second fuel cell portions 2195a and 2195b. First and second fuel cell portions 2195a and 2195b are electrically connected to fuel cell 2130 via a primary interconnect within primary interconnect region 2111. The first and second fuel cell portions 2195a and 2195b are separated in the direction of the width W of the substrate 2110 such that the first and second fuel cell portions 2195a and 2195b are electrically isolated. No continuous direct electrical path exists between the first and second fuel cell portions 2195a and 2195b, which are separated by a space of 1.5 mm in the direction of the width W of the substrate 2110. As shown in FIG. 14B, the space between fuel cell portions 2195a and 2195b includes dense barrier 2120c overlaid by electrolyte 2130c.

As shown in FIG. 14A, a first fuel cell connector 2145a is electrically connected to (and electrically connects) the first dummy cell portion 2180a of laterally segmented dummy cell 2180 and the first dummy cell portion 2185a of laterally segmented dummy cell 2185. As shown in FIGS. 13 and 14A, second fuel cell connector 2145b is electrically connected to (and electrically connects) the second dummy cell portion 2180b of laterally segmented dummy cell 2180 and the second dummy cell portion 2185b of laterally segmented dummy cell 2185.

In this example embodiment, the first fuel cell connector 2145a is electrically connected to (and in this example embodiment contacts) the cathode current collectors of the first dummy cell portions 2180a and 2185a, and the second fuel cell connector 2145b is electrically connected to (and in this example embodiment contacts) the cathode current collectors of the second dummy cell portions 2180b and 2185b. Since the first and second dummy cell portions 2180a and 2180b are electrically isolated, and the first and second dummy cell portions 2185a and 2185b are electrically isolated, the first and second fuel cell connectors 2145a and 2145b are electrically isolated such that there is no continuous electrical path across the width W of the substrate 2110. A glass edge seal 2146 fills the space between the fuel cell connector 2145a and the rest of fuel cell tube 2100. This glass edge seal 2146 extends down the full length of the fuel cell tube 2100 and prevents fuel from escaping the fuel cell structure, separating air and fuel. A glass edge seal 2146 also fills the space between fuel cell connector 2145b and the rest of fuel cell tube 2100. This glass edge seal 2146 extends down the full length of the fuel cell tube 2100 and prevents fuel from escaping the fuel cell structure, separating air and fuel.

As shown in FIG. 14B, a third fuel cell connector 2155a is electrically connected to (and electrically connects) the first fuel cell portion 2190a of laterally segmented fuel cell 2190 and the first fuel cell portion 2195a of laterally segmented fuel cell 2195. As shown in FIGS. 13 and 14B, a fourth fuel cell connector 2155b is electrically connected to (and electrically connects) the second fuel cell portion 2190b of laterally segmented fuel cell 2190 and the second fuel cell portion 2195b of laterally segmented fuel cell 2195.

In this example embodiment, the third fuel cell connector 2155a is electrically connected to (and in this example embodiment contacts) the cathode current collectors of the first fuel cell portions 2190a and 2195a, and the fourth fuel cell connector 2155b is electrically connected to (and in this example embodiment contacts) the cathode current collectors of the second fuel cell portions 2190b and 2195b. Since the first and second fuel cell portions 2190a and 2190b are electrically isolated and the first and second fuel cell portions 2195a and 2195b are electrically isolated, the third and fourth fuel cell connectors 2155a and 2155b are electrically isolated such that there is no continuous electrical path across the width W of the substrate 2110. A glass edge seal 2146 fills the space between the fuel cell connector 2155a and the rest of fuel cell tube 2100. This glass edge seal 2146 extends down the full length of the fuel cell tube 2100 and prevents fuel from escaping the fuel cell structure, separating air and fuel. A glass edge seal 2146 also fills the space between fuel cell connector 2155b and the rest of fuel cell tube 2100. This glass edge seal 2146 extends down the full length of the fuel cell tube 2100 and prevents fuel from escaping the fuel cell structure, separating air and fuel.

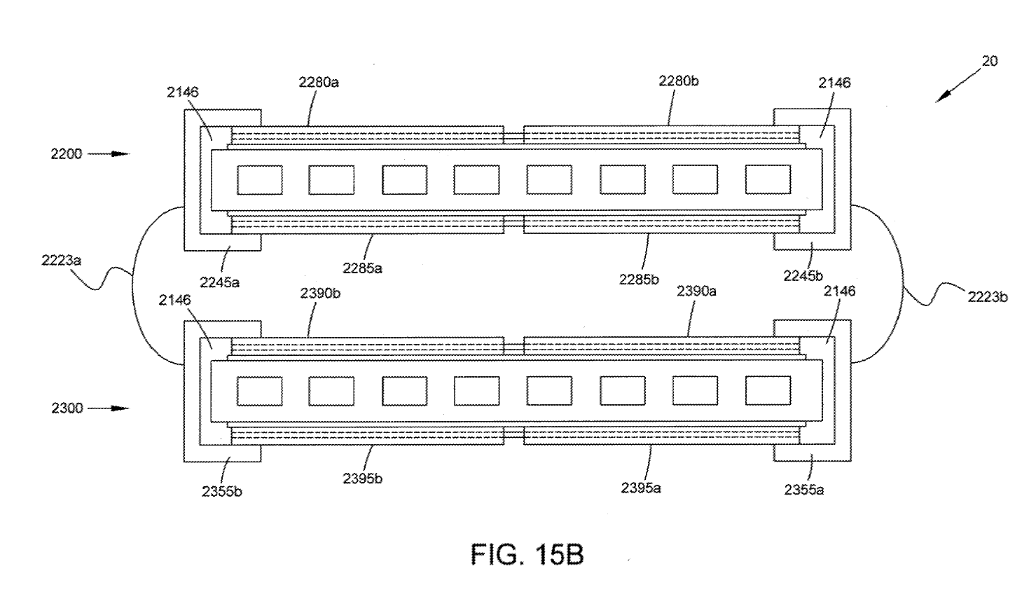

FIGS. 15A and 15B show three fuel cell tubes 2100, 2200, and 2300 of the fuel cell stack 20. While the fuel cell stack 20 may include any suitable quantity of fuel cell tubes electrically connected to one another in series, only three are shown here for clarity and brevity. In this example embodiment, the fuel cell tubes 2200 and 2300 are identical to the fuel cell tube 2100 and are therefore not separately described (though in other embodiments the fuel cell tubes may differ from one another). The element numbering schemes of the fuel cell tubes 2200 and 2300 correspond to the element numbering scheme used to describe the fuel cell tube 2100 such that like element numbers correspond to like components.

As shown in FIG. 15A, the first fuel cell tube 2100 is electrically connected to the second fuel cell tube 2200 via: (1) a first tube interconnect 2122a that electrically connects fuel cell connector 2145a of the first fuel cell tube 2100 to fuel cell connector 2255b of the second fuel cell tube 2200; and (2) a second tube interconnect 2122b that electrically connects fuel cell connector 2145b of the first fuel cell tube 2100 to fuel cell connector 2255a of the second fuel cell tube 2200. First tube interconnect 2122a electrically connects laterally segmented dummy cell portions 2180a and 2185a of the first fuel cell tube to laterally segmented fuel cell portions 2290b and 2295b of the second fuel cell tube. Second tube interconnect 2122b electrically connects laterally segmented dummy cell portions 2180b and 2185b to laterally segmented fuel cell portions 2290a and 2295a. Generally, the fuel cell tubes are connected in series with direction of the flow of fuel through the tubes.

As shown in FIG. 15B, the second fuel cell tube 2200 is electrically connected to the third fuel cell tube 2300 via: (1) a third tube interconnect 2223a that electrically connects fuel cell connector 2245a of the second fuel cell tube 2200 to fuel cell connector 2355b of the third fuel cell tube 2300; and (2) a fourth tube interconnect 2223b that electrically connects the fuel cell connector 2245b of the second fuel cell tube 2200 to fuel cell connector 2355a of the third fuel cell tube 2300. Third tube interconnect 2223a electrically connects laterally segmented dummy cell portions 2280a and 2285a of the second fuel cell tube to laterally segmented fuel cell portions 2390b and 2395b of the third fuel cell tube. Fourth tube interconnect 2223b electrically connects laterally segmented dummy cell portions 2280b and 2285b of the second fuel cell tube to laterally segmented fuel cell portions 2390a and 2395a of the third fuel cell tube.

The tube interconnects shown in the various embodiments (for example 2122a and 2122b in FIG. 15A) are illustrated as wires for exemplary purposes only. The present disclosure pertains to other designs for tube (secondary) interconnects such as the designs disclosed in the following co-pending applications: U.S. patent application Ser. No. 15/816,918, filed Nov. 17, 2017, entitled “Improved Fuel Cell Secondary Interconnect”; U.S. patent application Ser. No. 15/816,931, filed Nov. 17, 2017, entitled “Improved Fuel Cell Secondary Interconnect”; and U.S. patent application Ser. No. 15/816,948, filed Nov. 17, 2017, entitled “Multiple Fuel Cell Secondary Interconnect Bonding Pads And Wires”.

Various modifications to the embodiments described herein will be apparent to those skilled in the art. These modifications can be made without departing from the spirit and scope of the present disclosure and without diminishing its intended advantages. It is intended that such changes and modifications be covered by the appended claims.

1. A segmented-in-series solid-oxide fuel cell system comprising:
a first fuel cell tube comprising:
a substrate having a first end and an opposing second end, a first major surface extending between the first and second ends, and a second opposing major surface extending between the first and second ends; and
a plurality of fuel cells disposed on the first major surface, each fuel cell extending laterally across the first major surface and being positioned between the first and second ends, wherein a first selected one of the plurality of fuel cells on said first major surface proximate said first end is laterally segmented so that a first lateral end of the first selected fuel cell is electrically isolated from a second lateral end of the first selected fuel cell; and
wherein an interior selected one of the plurality of fuel cells is a fuel cell adjacent said first selected fuel cell;
wherein said interior selected one of the plurality of fuel cells is laterally segmented so that a first lateral end of the interior selected fuel cell is electrically isolated from a second lateral end of the interior selected fuel cell;
a second fuel cell tube comprising:
a substrate having a first end and an opposing second end, a first major surface extending between the first and second ends, and a second opposing major surface extending between the first and second ends; and
a plurality of fuel cells disposed on the first major surface, each fuel cell extending laterally across the first major surface and being positioned between the first and second ends, wherein a first selected one of the plurality of fuel cells on said first major surface proximate said second end is laterally segmented so that a first lateral end of the first selected fuel cell is electrically isolated from a second lateral end of the first selected fuel cell; and
a first tube interconnect electrically connecting the first lateral end of the first selected fuel cell of the first fuel cell tube to the second lateral end of the first selected fuel cell of the second fuel cell tube.

2. The segmented-in-series solid-oxide fuel cell system of claim 1, further comprising a second tube interconnect electrically connecting the second lateral end of the first selected fuel cell of the first fuel cell tube to the first lateral end of the first selected fuel cell of the second fuel cell tube.

3. The segmented-in-series solid-oxide fuel cell system of claim 1, further comprising:
said second fuel cell tube wherein a second selected one of the plurality of fuel cells on said first major surface proximate said first end is laterally segmented so that a first lateral end of the second selected fuel cell is electrically isolated from a second lateral end of the second selected fuel cell; and
said second fuel cell tube wherein a first interior selected one of the plurality of fuel cells is a fuel cell adjacent said second selected fuel cell;
said second fuel cell tube wherein said first interior selected one of the plurality of fuel cells is laterally segmented so that a first lateral end of the first interior selected fuel cell is electrically isolated from a second lateral end of the first interior selected fuel cell;
a third fuel cell tube comprising:
a substrate having a first end and an opposing second end, a first major surface extending between the first and second ends, and a second opposing major surface extending between the first and second ends; and
a plurality of fuel cells disposed on the first major surface, each fuel cell extending laterally across the first major surface and being positioned between the first and second ends, wherein a first selected one of the plurality of fuel cells on said first major surface proximate said second end is laterally segmented so that a first lateral end of the first selected fuel cell is electrically isolated from a second lateral end of the first selected fuel cell; and
a third tube interconnect electrically connecting the first lateral end of the second selected fuel cell of the second fuel cell tube to the second lateral end of the first selected fuel cell of the third fuel cell tube.

4. The segmented-in-series solid-oxide fuel cell system of claim 3, further comprising a fourth tube interconnect electrically connecting the second lateral end of the second selected fuel cell of the second fuel cell tube to the first lateral end of the first selected fuel cell of the third fuel cell tube.

5. The segmented-in-series solid-oxide fuel cell system of claim 4, further comprising a second tube interconnect electrically connecting the second lateral end of the first selected fuel cell of the first fuel cell tube to the first lateral end of the first selected fuel cell of the second fuel cell tube.

6. The segmented-in-series solid-oxide fuel cell system of claim 5, further comprising a first primary interconnect electrically connecting the first selected one of the plurality of fuel cells of the first fuel cell tube to the interior selected one of the plurality of fuel cells of the first fuel cell tube, wherein a first lateral end of the first primary interconnect is electrically isolated from a second lateral end of the first primary interconnect.

7. The segmented-in-series solid-oxide fuel cell system of claim 6, further comprising a second primary interconnect electrically connecting the second selected one of the plurality of fuel cells of the second fuel cell tube to the interior selected one of the plurality of fuel cells of the second fuel cell tube, wherein a first lateral end of the second primary interconnect is electrically isolated from a second lateral end of the second primary interconnect.

8. A fuel cell tube comprising:
a substrate defining one or more fuel conduits therethrough, the substrate having a first end and an opposing second end, a first major surface extending between the first and second ends, and a second opposing major surface extending between the first and second ends; and
a plurality of fuel cells disposed on the first major surface, each fuel cell extending laterally across the first major surface and being positioned between the first and second ends, wherein a first selected one of the plurality of fuel cells on said first major surface proximate said first end is laterally segmented so that a first lateral end of the first selected fuel cell is electrically isolated from a second lateral end of the first selected fuel cell; and
wherein a first interior selected one of the plurality of fuel cells disposed on the first major surface is a fuel cell adjacent said first selected fuel cell;
wherein said first interior selected one of the plurality of fuel cells is laterally segmented so that a first lateral end of the first interior selected fuel cell is electrically isolated from a second lateral end of the first interior selected fuel cell.

9. The fuel cell tube of claim 8, wherein a second selected one of the plurality of fuel cells on said first major surface proximate said second end is laterally segmented so that a first lateral end of the second selected fuel cell is electrically isolated from a second lateral end of the second selected fuel cell.

10. The fuel cell tube of claim 8 further comprising:
a plurality of fuel cells disposed on the second major surface, each fuel cell extending laterally across the second major surface and being positioned between the first and second ends, wherein a first selected one of the plurality of fuel cells on said second major surface proximate said first end is laterally segmented so that a first lateral end of the first selected fuel cell on said second major surface is electrically isolated from a second lateral end of the first selected fuel cell on said second major surface; and
wherein a first interior selected one of the plurality of fuel cells disposed on the second major surface is a fuel cell adjacent said first selected fuel cell on said second major surface;
wherein said first interior selected one of the plurality of fuel cells on said second major surface is laterally segmented so that a first lateral end of the first interior selected fuel cell on said second major surface is electrically isolated from a second lateral end of the first interior selected fuel cell on said second major surface.

11. The fuel cell tube of claim 10, wherein a second selected one of the plurality of fuel cells on said second major surface proximate said second end is laterally segmented so that a first lateral end of the second selected fuel cell on said second major surface is electrically isolated from a second lateral end of the second selected fuel cell on said second major surface.

12. The fuel cell tube of claim 11, further comprising a first fuel cell connector electrically connecting the first lateral end of the first selected fuel cell of the plurality of fuel cells on said first major surface to the first lateral end of the first selected fuel cell of the plurality of fuel cells on said second major surface.

13. The fuel cell tube of claim 12, further comprising a second fuel cell connector electrically connecting the second lateral end of the first selected fuel cell of the plurality of fuel cells on the first major surface to the second lateral end of the first selected fuel cell of the plurality of fuel cells on the second major surface.

14. The fuel cell tube of claim 13, further comprising a first primary interconnect electrically connecting the first selected one of the plurality of fuel cells on the first major surface to the first interior selected one of the plurality of fuel cells on the first major surface, wherein a first lateral end of the first primary interconnect is electrically isolated from a second lateral end of the first primary interconnect.

15. The fuel cell tube of claim 14, further comprising a second primary interconnect electrically connecting the first selected one of the plurality of fuel cells on the second major surface to the first interior selected one of the plurality of fuel cells on the second major surface, wherein a first lateral end of the second primary interconnect is electrically isolated from a second lateral end of the second primary interconnect.
